(19) United States
(12) Patent Application Publication
(10) Pub. No.: US 2020/0164881 A1
(43) Pub. Date: May 28, 2020

(54) VEHICLE PASSING CONTROLLER

(71) Applicant: INTERNATIONAL BUSINESS MACHINES CORPORATION, ARMONK, NY (US)

(72) Inventors: Sarbajit K. Rakshit, Kolkata (IN); James E. Bostick, Cedar Park, TX (US); John M. Ganci, JR., Raleigh, NC (US); Martin G. Keen, Cary, NC (US)

(21) Appl. No.: 16/202,309

(22) Filed: Nov. 28, 2018

(51) Int. Cl. B60W 30/18; G05D 1/00

(52) U.S. Cl. CPC B60W 30/18163; G05D 1/0088; G05D 2201/0213; B60W 2400/00; B60W 2550/302; B60W 2550/142; B60W 2530/10; B60W 2720/106; B60W 2550/306; B60W 2550/145

(57) ABSTRACT

Aspects of the present invention provide devices that receive data indicative of speed, position and direction of a first vehicle and nearby vehicles on a road, determine a passing power of the first vehicle according to characteristics of the road and operating characteristics of the first vehicle, determine safe passing by the first vehicle of one of the nearby vehicles on the road according to the received data and the determined passing power of the first vehicle, and govern the first vehicle according to the determined safe passing.

### BACKGROUND

The field of vehicle navigation and control includes the application of computer technology to the governance and guidance of the vehicle, specifically control to pass other vehicles on a road.

Vehicles operating on the roadways, such as highways, roads, streets, etc. include autonomous, semi-autonomous, and independent driver operated vehicles. The autonomous vehicles include vehicle navigation and control systems which automatically operate the vehicle independent of occupants of the vehicle. Semi-autonomous vehicles include safety features that can override driver operation of the vehicles, such as automatic braking. Independent driver operated vehicles can include vehicle navigation and control systems, which provide recommendations or indicators to the driver of the vehicle.

Vehicle navigation and control systems conventionally include systems, which based on a vehicle speed, position and direction, and speeds, positions and directions of nearby vehicles determine whether the vehicle can safely pass another vehicle. Passing changes the order of vehicles in a lane of the road. Vehicle navigation and control systems conventionally include sensors, which determine the relative positions of the vehicles or other measurements of speed, position and direction according to cellular transmissions and global positioning systems (GPS).

Vehicle systems conventionally include communications, such as cellular communication, either through a cellular phone built into the vehicle or through phones of vehicle occupants wirelessly connected to the vehicle for hands free operation. Vehicle systems conventionally include processors, which provide set-up and maintenance of communications within the vehicle and between the vehicle and devices external to the vehicle. Vehicle systems include memory and storage of vehicle configurations, such as typically used for servicing of the vehicle. For example, vehicle configurations include vehicle identification, engine identification and/or characteristics, which can be automatically communicated to servicing equipment during vehicle servicing and tuning.

### BRIEF SUMMARY

In one aspect of the present invention, a computer-implemented method for controlling vehicle passing includes executing a computer processor receiving data indicative of speed, position and direction of a first vehicle and nearby vehicles on a road, determining a passing power of the first vehicle according to characteristics of the road and operating characteristics of the first vehicle, determining safe passing by the first vehicle of one of the nearby vehicles on the road according to the received data and the determined passing power of the first vehicle, and governing the first vehicle according to the determined safe passing.

In another aspect, a system has a hardware computer processor, computer readable memory in circuit communication with the computer processor, and a computer-readable storage medium in circuit communication with the computer processor and having program instructions stored thereon. The computer processor executes the program instructions stored on the computer-readable storage medium via the computer readable memory and thereby controls vehicle passing, which receives data indicative of speed, position and direction of a first vehicle and nearby vehicles on a road, determines a passing power of the first vehicle according to characteristics of the road and operating characteristics of the first vehicle, determines safe passing by the first vehicle of one of the nearby vehicles on the road according to the received data and the determined passing power of the first vehicle, and governs the first vehicle according to the determined safe passing.

In another aspect, a computer program product for controlling vehicle passing has a computer-readable storage medium with computer readable program code embodied therewith. The computer readable program code includes instructions for execution by a computer processor that cause the computer processor to receive data indicative of speed, position and direction of a first vehicle and nearby vehicles on a road, determine a passing power of the first vehicle according to characteristics of the road and operating characteristics of the first vehicle, determine safe passing by the first vehicle of one of the nearby vehicles on the road according to the received data and the determined passing power of the first vehicle, and govern the first vehicle according to the determined safe passing.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts abstraction model layers according to an embodiment of the present invention.

FIG. 3 depicts a computerized aspect according to an embodiment of the present invention.

FIG. 4 depicts an example schematic illustration of an embodiment of the present invention.

FIG. 5 depicts an example schematic illustration of an embodiment of the present invention.

FIG. 6 is a flow chart illustration of an embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e- mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

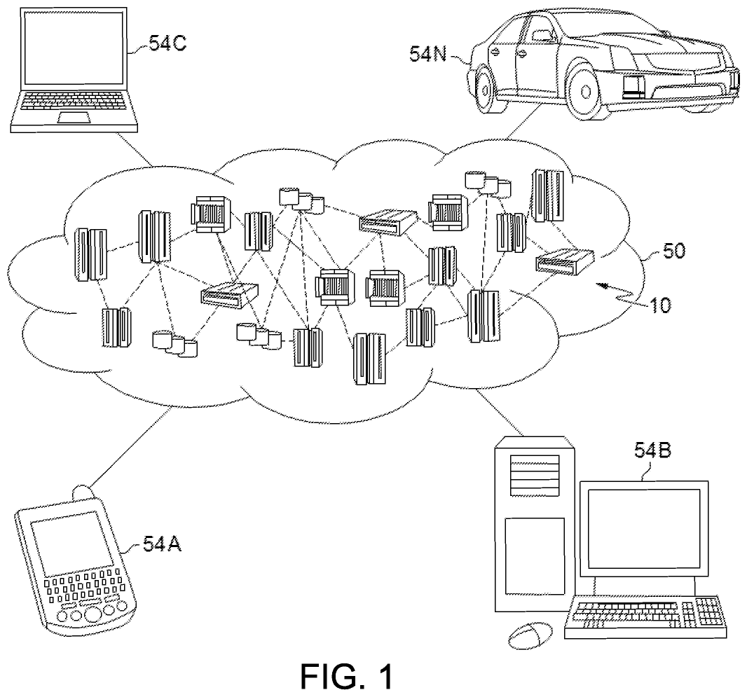

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

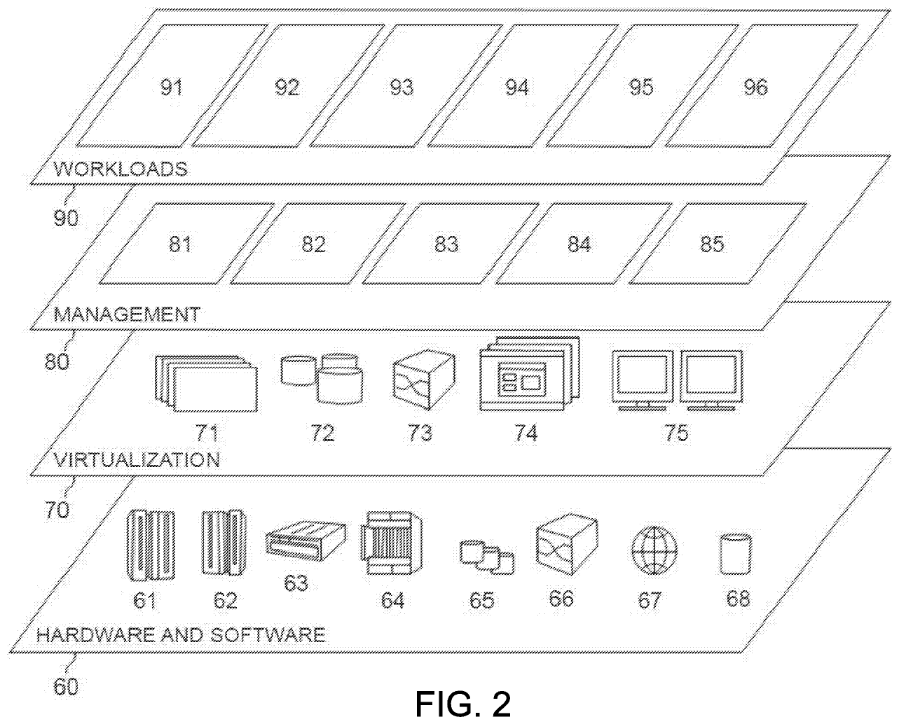

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing for controlling vehicle passing 96.

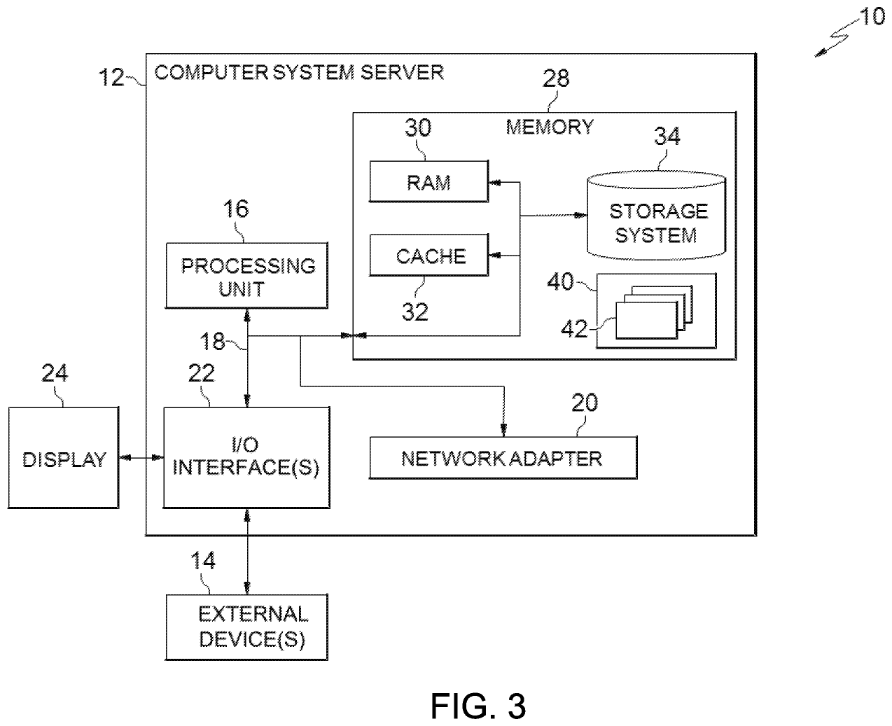

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

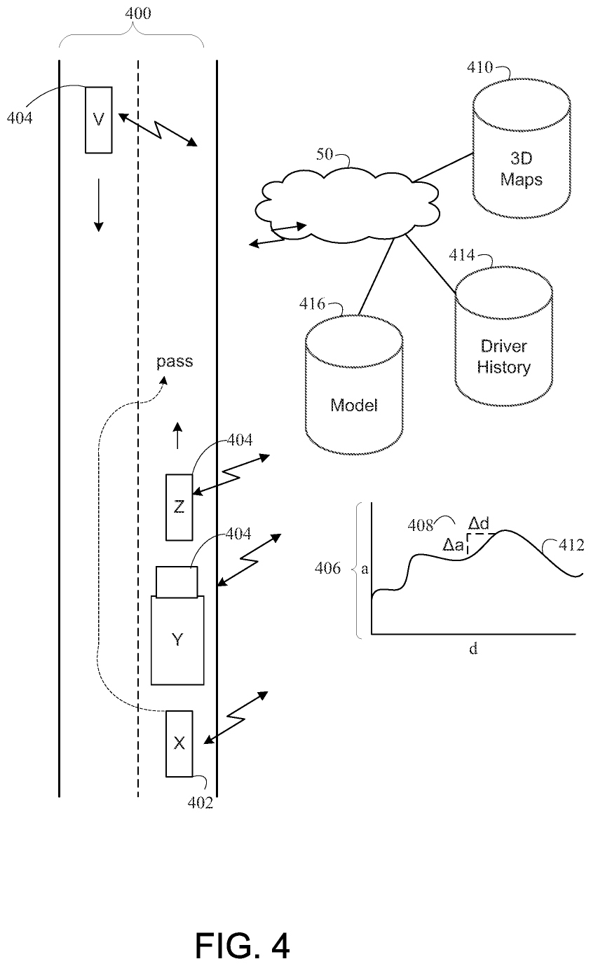

FIG. 4 schematically illustrates an example according to the present invention for controlling a vehicle 402 passing on a road 400, such as a bi-directional road. The bi-directional road includes a single lane in each direction with a dotted traffic line indicator between the lanes. In order to pass vehicles in a current lane, the vehicle must move into the lane of opposing traffic.

Data indicative of speeds, positions, and directions of a first vehicle 402, labeled X, and nearby vehicles 404, labeled Y, Z, and V, are received by a configured processor, such as the processing unit 16 of the computer system/server 12, as described in reference to FIG. 3. The configured processor can be located in the cloud 50, in the first vehicle 402, or distributed between the cloud 50 and the first vehicle 402.

The speeds, positions and directions are communicated from each vehicle to the cloud 50. The speeds, positions and directions of the first vehicle 402 and nearby vehicles 404 can be determined from Global positioning satellite (GPS) devices, cellular data, cameras and image analysis, and combinations thereof. For example, GPS devices include devices installed on a vehicle, GPS devices installed in the local computing devices 54 in the possession of occupants of the vehicle and combinations thereof. In some embodiments, information about the position, speed and direction can be obtained from triangulation of cellular communications and cell tower positions. In some embodiments, cameras located on the vehicles, along the road and combinations thereof provide information for speed, position and direction.

Nearby vehicles 404 can be determined from function of the speed and position of the first vehicle 402. That is, as the speed of the first vehicle 402 increases the passing distance increases, and as the passing distance increases the distance between the first vehicle 402 and vehicles included in the nearby vehicles 404 increases. For example, a radius around the position of the first vehicle 402 includes vehicles on the same road as a function of the speed of the first vehicle. In some embodiments, the function includes a parameter for bi-directional roads and/or uni-directional roads. In some embodiments, the vehicles defined as nearby vehicles 404 includes a fixed maximum distance from the position of the first vehicle 402, such as 2 miles.

The configured processor determines a passing power of the first vehicle 402 according to characteristics of the road and operating characteristics of the first vehicle 402, The configured processor can further determine a power of one or more nearby vehicles according the characteristics of the road and operating characteristics of the corresponding nearby vehicle.

The ability of each vehicle to accelerate, decelerate, and/or maintain a speed on the road 400 in passing conditions can change with characteristics of the road 400, such as an altitude 406 of the road 400, a gradient 408 of the road 400, and combinations thereof. From the position and direction of the first vehicle 402, the altitude 406 and the gradient 408 of the road 400 can be obtained from three dimensional maps 410. For example, a two-dimensional graph of a segment 412 of the road 400 with distance along a horizontal axis and altitude along a vertical axis indicates the gradient 408, such as Aa/Ad, wherein Aa is a change in the altitude 406 and Ad is a corresponding change in distance. The change in the altitude 406 and/or the gradient 408 can be a function of each, respectively, such as an average, a minimum, a maximum, a variance, an integration of a function fitted to the graph segment over the change in distance, etc.

The operating characteristics of the first vehicle 402 include a vehicle weight and an engine power. The vehicle weight and the engine power can be determined from memory of the vehicle, such as used for vehicle maintenance.

The configured processor can obtain driver passing characteristics of at least one driver, such as of the first vehicle 402, one or more of the nearby vehicles 404, and combinations thereof. The driver can be identified by biometrics, direct input, the local computing device 54 in the possession of the driver, and combinations thereof. In some embodiments, at least one vehicle of a combination of the first vehicle 402 and the nearby vehicles 404 is a semi- autonomous vehicle or an independent driver operated vehicle. The driver passing characteristics can be determined from a history of drivers 414. For example, the history of drivers 414 can include prior successful and unsuccessful passing attempts, responses of nearby drivers during the passing attempts, and the like.

The configured processor determines safe passing by the first vehicle 402 of one of the nearby vehicles on the road 400 according to the received data and the determined passing power of the first vehicle. The determined safe passing can include an indicator, such as a binary value indicative of safe or unsafe passing. In some embodiments, the determined safe passing can include a computed time interval. In some embodiments, the computed time interval includes the time remaining to begin the safe passing, such as accelerating and changing lanes. For example, the configured processor based on the vehicle power and received data computes a time to pass of 28 seconds of the nearby vehicles, and will continue to be safe passing for the next 10 seconds. That is, the first vehicle 402 has 10 seconds to initiate the safe passing, and a time to complete the safe passing is computed to be 28 seconds. In some embodiments, the time to initiate and the time to pass are displayed on a display device 24, such as a dashboard display of the first vehicle 402.

In some embodiments, a determined safe passing of an unsafe condition can include a time to determined safe passing. For example, the configured processor determines an unsafe condition due to an oncoming nearby vehicle, which exists for 7 seconds. After the 7 seconds, the oncoming nearby vehicle will pass and a safe condition exists afterwards.

The configured processor uses a model 416, such as a deep learning model, support vector machines, Bayesian networks, neural networks, linear regression models, long short term memory (LSTM), and the like, to input the received data indicative of speed, position and direction of the vehicles, the road characteristics, and the vehicle characteristics; analyze the received data, the road characteristics, and the vehicle characteristics; and output a determined safe passing.

In some embodiments, the inputs and the analysis of the model 416 include one or more driver passing characteristics. For example, the inputs and analysis can include driver passing characteristics of a driver of the first vehicle 402, a driver of a nearby vehicle 404, and combinations thereof.

In some embodiments the inputs and the analysis of the model 416 include the determined power of at least one nearby vehicle 404. For example, the determined power of the nearby vehicle 404 in front of the first vehicle 402 can include power characteristics such that the nearby vehicle 404 will slow in the segment 412 and thereby shorten the distance and corresponding time for safe passing of the nearby vehicle 404 in front of the first vehicle 402 by the first vehicle 402. In another example, the nearby vehicle 404 is a vehicle traveling in the passing lane in the opposite direction and in an uphill grade. The power of the vehicle traveling in the passing lane in the opposite direction is such that the vehicle will slow in the uphill grade and thereby increase the distance and time for safe passing.

The configured processor governs the first vehicle according to the determined safe passing. In some embodiments governing includes displaying the indicators of safe passing, such as a safe passing condition and alternatively an unsafe passing condition. In some embodiments, governing controls a throttle of the first vehicle 402 to prevent an unsafe condition. In some embodiments, governing include changing the throttle and navigation of the first vehicle 402 to pass the nearby vehicle 404.

The present invention provides improvements over conventional vehicle control and navigation systems. For example, conventional passing control considers speed without effect of vehicle passing power, such as the passing power of the first vehicle 402, the passing power of the nearby vehicles 404, and combinations thereof. Conventional passing speeds do not include vehicle operating characteristics, such as weight and engine power, and do not include road characteristics, such as altitude and gradient.

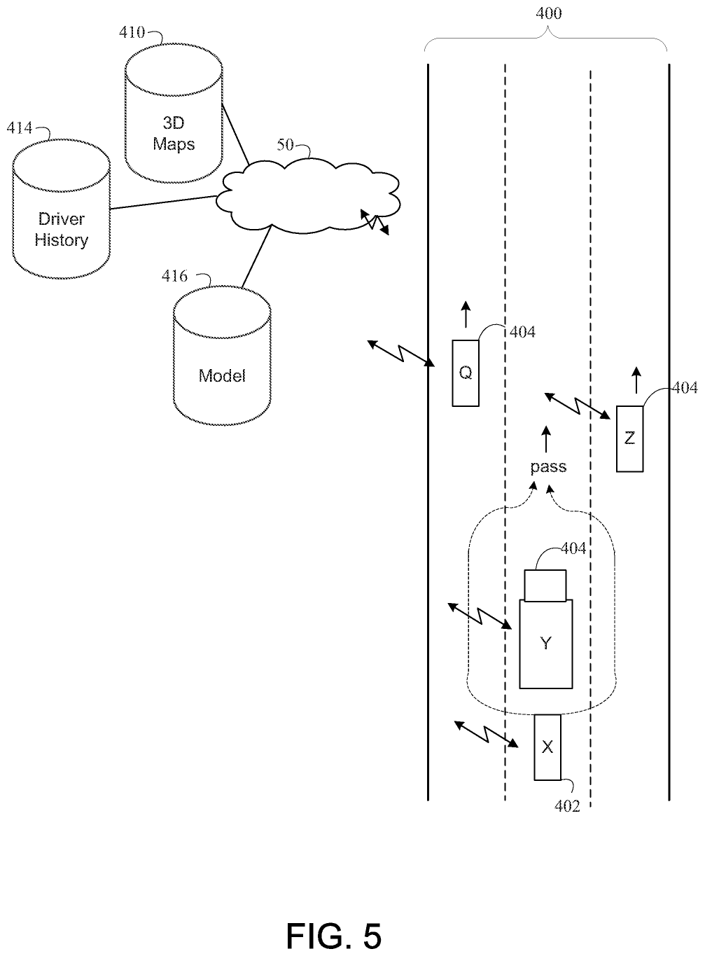

FIG. 5 schematically illustrates one embodiment of the present invention for controlling vehicle passing. The road 400 is illustrated as a multi-lane uni-directional road with three lanes. The configured processor determines the speed, position, and direction of the first vehicle 402 and nearby vehicles 404 relative to each other on the road 400.

The configured processor determines the passing power of one or more vehicles, such as the first vehicle 402, the nearby vehicles 404, and combinations thereof according to characteristics of the road obtained from the 3D maps 410 and operating characteristics of the corresponding vehicle. The nearby vehicles 404 can include one or more vehicles in the same lane preceding the first vehicle 402, one or more vehicles in a lane to the left of the first vehicle 402, one or more vehicles in a lane to the right of the first vehicle 402, and combinations thereof

The configured processor determines safe passing according to the received data, determined passing speed of the first vehicle 402, and driver passing characteristics of at least one driver, such as the nearby vehicle 404 immediately preceding the first vehicle 402 in the same lane. The configured processor uses the model 416 to determine the safe passing. The driver passing characteristics can include changes in speed according to prior responses to passing vehicles determined from the driver history 414, such as increase speed while being passed, decreasing speed while being passed, and combinations thereof. For example, some drivers will increase speed temporarily as another vehicle approaches for passing, only to return to a previous speed as passing continues. In some embodiments, the driver passing characteristics can include driver characteristics of the first vehicle 402, other nearby vehicles, and combinations thereof. In some embodiments, the driver passing characteristics includes changes to constant speed during a passing, the speed during passing, a type of road, a type of vehicle driven, and combinations thereof. The driver passing characteristics can be stored in and obtained from the memory 28.

In some instances, the determined safe passing can include a lane for passing, such as to the right or left. For example, laws typically indicate passing on the left of the nearby vehicle 404, while customs may suggest safe passing on the right of the nearby vehicle 404. The indicator of safe passing displayed on the display of the first vehicle 402 may further include a passing direction, such as an arrow pointing to the left or to the right.

The configured processor governs the first vehicle 402 according to the determined safe passing, such as displaying the indicator of safe passing, controlling the throttle of the first vehicle 402, changing the direction of the first vehicle 402 to another lane, and combinations thereof

The present invention provides further improvements over conventional vehicle control and navigation systems. For example, conventional passing control do not consider driver behavior during passing, such as changing speeds of nearby vehicles in response to vehicles attempting to pass. The changing speeds of independent driver operated and semi-autonomous nearby vehicles can alter the time and/or distances to achieve a successful passing.

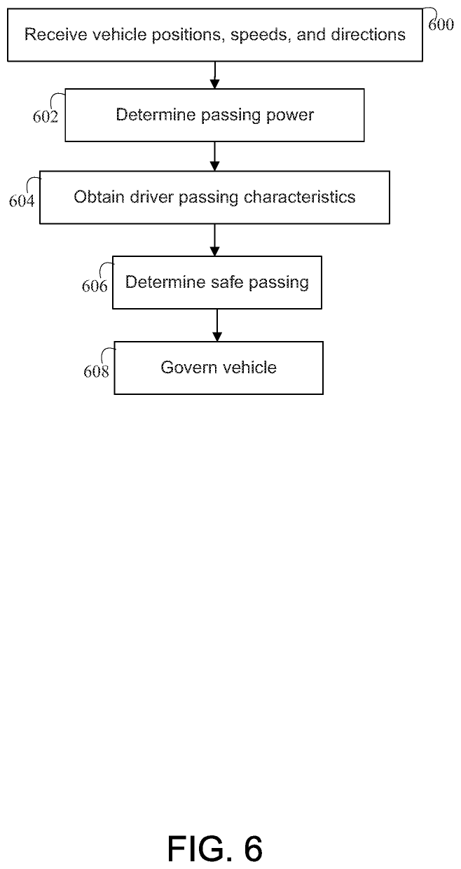

FIG. 6 illustrates one embodiment of a method of the present invention for controlling vehicle passing. At 600, the configured processor receives data indicative of speed, position and direction of the first vehicle 402 and nearby vehicles 404 on the road 400. The nearby vehicles 404 include vehicles within a function of the distance according to the speed of the first vehicle 402. In some embodiments, the function of the distance includes a predetermined fixed distance. The nearby vehicles 404 include at least one vehicle in the same lane of and preceding the first vehicle 402. The road 400 can include two lanes, each in an opposing direction of travel, two or more lanes in a single direction of travel, and combinations thereof

At 602, the configured processor determines a passing power of the first vehicle 402 according to characteristics of the road 400 and operating characteristics of the first vehicle 402. The passing power can be further determined for one or more of the nearby vehicles 404.

At 604, the configured processor can obtain the driver passing characteristics of at least one vehicle, such as the driver of the first vehicle 402, the drivers of one or more nearby vehicles 404 and combinations thereof. The driver passing characteristics include changes in speed according to prior responses to passing vehicles. In some embodiments, the driver passing characteristics include changes in speed according to prior responses to attempting to pass or pass nearby vehicles by the driver of the first vehicle 402.

At 606, the configured processor determines safe passing by the first vehicle of one of the nearby vehicles on the road according to the received data and the determined passing power of the first vehicle. In some embodiments, the determined safe passing includes determining safe passing according to the received data, the determined passing power of the first vehicle, and the driver passing characteristics.

At 608, the configured processor governs the first vehicle according to the determined safe passing. The governing can include displaying the indicator for safe passing on the display of the first vehicle 402, throttling the engine of the first vehicle 402, changing the direction of the first vehicle into a passing lane, and combinations thereof

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims, and as illustrated in the figures, may be distinguished, or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations, or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for controlling vehicle passing, comprising executing on a computer processor:
receiving data indicative of speed, position and direction of a first vehicle and nearby vehicles on a road;
determining a passing power of the first vehicle according to characteristics of the road and operating characteristics of the first vehicle;
determining safe passing by the first vehicle of one of the nearby vehicles on the road according to the received data and the determined passing power of the first vehicle; and
governing the first vehicle according to the determined safe passing.

2. The method of claim 1, further including:
obtaining driver passing characteristics of at least one driver; and
wherein determining safe passing by the first vehicle includes determining safe passing according to the received data, determined passing speed of the first vehicle and driver passing characteristics of the at least one driver.

3. The method of claim 1, wherein the operating characteristics of the first vehicle include a vehicle weight and an engine power.

4. The method of claim 1, wherein characteristics of the road include an altitude and a gradient.

5. The method of claim 1, wherein governing the first vehicle includes:
displaying an indicator on a display of the first vehicle indicative of the determined safe passing; and
in response to the determined safe passing indicating unsafe conditions limiting a speed of the first vehicle.

6. The method of claim 5, wherein nearby vehicles include vehicles on the road within a distance computed as a function of the speed of the first vehicle with a maximum distance of 2 miles.

7. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer readable storage medium via the computer readable memory and thereby receiving data indicative of speed, position and direction of the first vehicle and nearby vehicles, determining a passing power of the first vehicle, determining safe passing by the first vehicle of one of the nearby vehicles on the road, and governing the first vehicle according to the determined safe passing.

8. The method of claim 7, wherein the computer-readable program code is provided as a service in a cloud environment.

9. A system for controlling vehicle passing, comprising:
a computer processor;
a computer readable memory in circuit communication with the computer processor; and
a computer readable storage medium in circuit communication with the computer processor;
wherein the computer processor executes program instructions stored on the computer readable storage medium via the computer readable memory and thereby:
receives data indicative of speed, position and direction of a first vehicle and nearby vehicles on a road;
determines a passing power of the first vehicle according to characteristics of the road and operating characteristics of the first vehicle;
determines safe passing by the first vehicle of one of the nearby vehicles on the road according to the received data and the determined passing power of the first vehicle; and
governs the first vehicle according to the determined safe passing.

10. The system of claim 9, wherein the processor executes program instructions stored on the computer readable storage medium via the computer readable memory and thereby:
obtains driver passing characteristics of at least one driver; and
determines safe passing according to the received data, determined passing speed of the first vehicle and driver passing characteristics of the at least one driver.

11. The system of claim 9, wherein the operating characteristics of the first vehicle include a vehicle weight and an engine power.

12. The system of claim 9, wherein characteristics of the road include an altitude and a gradient.

13. The system of claim 9, wherein the processor executes program instructions stored on the computer readable storage medium via the computer readable memory and thereby:
displays an indicator on a display of the first vehicle indicative of the determined safe passing; and
in response to the determined safe passing indicating unsafe conditions limits a speed of the first vehicle.

14. The system of claim 13, wherein nearby vehicles include vehicles on the road within a distance computed as a function of the speed of the first vehicle with a maximum distance of 2 miles.

15. A computer program product for controlling vehicle passing, the computer program product comprising:
a computer readable storage medium having computer readable program code embodied therewith, the computer readable program code comprising instructions for execution by a computer processor that causes the computer processor to:
receive data indicative of speed, position and direction of a first vehicle and nearby vehicles on a road;
determine a passing power of the first vehicle according to characteristics of the road and operating characteristics of the first vehicle;
determine safe passing by the first vehicle of one of the nearby vehicles on the road according to the received data and the determined passing power of the first vehicle; and
govern the first vehicle according to the determined safe passing.

16. The computer program product of claim 15, wherein the instructions for execution cause the computer processor to:
obtain driver passing characteristics of at least one driver; and
determine safe passing according to the received data, determined passing speed of the first vehicle and driver passing characteristics of the at least one driver.

17. The computer program product of claim 16, wherein the operating characteristics of the first vehicle include a vehicle weight and an engine power.

18. The computer program product of claim 15, wherein characteristics of the road include an altitude and a gradient.

19. The computer program product of claim 15, wherein the instructions for execution cause the computer processor to:
display an indicator on a display of the first vehicle indicative of the determined safe passing; and
in response to the determined safe passing indicating unsafe conditions limit a speed of the first vehicle.

20. The computer program product of claim 19, wherein nearby vehicles include vehicles on the road within a distance computed as a function of the speed of the first vehicle with a maximum distance of 2 miles.
